(19) United States
(12) Patent Application Publication
(10) Pub. No.: US 2002/0053876 A1
(43) Pub. Date: May 9, 2002

(54) GAS-DISCHARGE DISPLAY PANEL, A DISPLAY USING THE SAME, AND A METHOD OF MANUFACTURING THE SAME

(76) Inventors: MICHIFUMI KAWAI, TOKYO (JP); RYOHEI SATOH, YOKOHAMA-SHI (JP); SHOICHI IWANAGA, YOKOHAMA-SHI (JP); SHIGEAKI SUZUKI, FUJISAWA-SHI (JP); KAZUO SUZUKI, YOKOHAMA-SHI (JP); SHIGEHISA MOTOWAKI, YOKOHAMA-SHI (JP); YOSHIHIRO KATO, YOKOHAMA-SHI (JP); YUTAKA NAITO, TOKYO (JP)

Correspondence Address: ANTONELLI TERRY STOUT & KRAUS, SUITE 1800, 1300 NORTH SEVENTEENTH STREET, ARLINGTON, VA, 22209

(21) Appl. No.: 09/130,151

(22) Filed: Aug. 6, 1998

(30) Foreign Application Priority Data
Aug. 8, 1997 (JP) 09-214393

(51) Int. Cl. H01J 17/49

(52) U.S. Cl. 313/587

(57) ABSTRACT

A gas-discharge display panel is manufactured by sealing up a front substrate and a rear substrate by a sealing member. A relationship of Tg≧Tf exists between a glass transition point Tg of a dielectric substance formed on the front substrate and a temperature Tf at which the front substrate and the rear substrate are sealed up.

### BACKGROUND OF THE INVENTION

The present invention relates to a gas-discharge display panel such as a plasma display panel and a display using the same.

Since the gas-discharge display panel such as a plasma display panel achieves a display operation through a self-emission, there are obtained a large angle of visual field and improved visibleness of displayed images. Moreover, the gas-discharge displays have the following aspects, for example, it is possible to produce a display with a reduced thickness and there can be fabricated a large-sized screen, and hence gas-discharge displays have already been put to use for information terminal facilities and high-definition television sets. The plasma displays can be fundamentally classified into a direct-current (dc) type and an alternate-current (ac) type. Of these types of displays, the ac plasma displays have a high luminance thanks to a memory action of a dielectric layer coating electrodes, and there can be obtained a life for practices owing to the formation of protective layers. As a result, the plasma display is practically adopted as a multipurpose video monitor.

FIG. 4 is a perspective view showing constitution of a plasma display panel practically used. In this diagram, a front substrate 100 is apart from a rear substrate 200 and a discharging region 300 for easy understanding of the constitution.

In the constitution, the front substrate 100 includes a front glass substrate 400 on which display electrodes 600 including a transparent conductive material such as indium tin oxide (ITO) and tin oxide (SnO₂), bus electrodes 700 including a low-resistance material, a dielectric layer 800 including a transparent insulating material, and a protective layer 900 including magnesium oxide (MgO) are fabricated.

The rear substrate 200 includes address electrodes 100, barrier ribs 1100, and a fluorescent layer 1200 on a rear glass substrate 500. Additionally, although not shown, a dielectric layer 1300 is also formed on the address electrodes 1000.

Moreover, the front substrate 100 is fixed onto the rear substrate 200 such that the display electrodes (transparent electrodes) 600 are orthogonal to the address electrodes 1000, which forms the discharging region 300 between the front substrate 100 and the rear substrate 200.

In addition, although not shown, to fill a discharge gas into a space between the front substrate 100 and the rear substrate 200, the construction includes peripheral portions sealed with a sealing member including a glass material.

In this gas-discharge display, when an ac voltage is applied between a pair of display electrodes 600 disposed on the front substrate 100 and a voltage is applied between the address electrode 1000 and the display electrode 600, there takes place an address discharge to lead to a main discharge in a predetermined discharge cell. Using an ultraviolet ray generated by the main discharge, fluorescent substances 1200 of red, green, and blue respectively painted on the respective discharge cells emit lights so as to conduct the display operation. Respective voltages are applied to the respective electrodes by a driving circuit not show in the drawings.

A conventional example of the gas-discharge display shown above has been described in pages 208 to 215 of the “Flat Panel Display 1996” published from Nikkei Micro-Device in 1995.

### SUMMARY OF THE INVENTION

It is therefore an object of the present invention to provide a gas-discharge display panel having a high picture quality capable of preventing occurrence of cracks in a protective layer which has a high secondary-electron emission characteristic and which is disposed on a dielectric layer.

Another object of the present invention is to provide a gas-discharge display panel in which a sealing material has high reliability in a high-temperature process to thereby produce high-quality pictures.

In the plasma display panel of this kind, there is included the protecting layer 900 of MgO or the like having a high value of the secondary electron emission characteristic for the emission of light from the fluorescent substance 1200. There arises a great problem of cracks in the protecting layer 900. When cracks appear in the protecting layer 900, the quality of picture itself is deteriorated.

A first problem to be solved by the present invention is how to prevent cracks from appearing in the thin MgO film on the dielectric layer.

On the other hand, in the configuration of the conventional plasma display panel, the front substrate 100 and the rear substrate 200 are sealed up. In some cases, the sealed panel is treated at a high temperature to activate the protecting layer 900 of MgO. In this case, although it is desired to activate the protecting layer 900 of MgO at a possibly high temperature, the temperature is limited to the temperature at which the front substrate 100 and the rear substrate 200 are sealed up. This is because of a fear that when the activation process is accomplished at a temperature exceeding the sealing temperature, the sealing material is softened and hence the joining strength is deteriorated between the front substrate 100 and the rear substrate 200 and the sealed discharge gas such as a rare gas leaks therefrom.

A second problem to be solved by the present invention is how to increase reliability of the sealing material in the high-temperature process.

Through discussion on the cause of occurrence of cracks in the thin MgO film, it has been known that the occurrence of cracks is closely related to the temperature Tf at which the front substrate 100 and the rear substrate 200 are sealed up with the sealing material. That is, the thin MgO film is formed on the dielectric substance fabricated in a thick-film process in which there exists a difference in thermal expansion between the dielectric layer and the thin MgO film. Consequently, these substances respectively thermally expand and the difference in thermal expansion leads to the cracks.

FIG. 5 shows a relationship between temperature and thermal expansion for the dielectric material and MgO. As can be seen from this graph, the thermal expansion almost linearly increases with respect to temperature. However, the dielectric material generally employed in the plasma display panels is a glass substance and hence the thermal expansion thereof abruptly increases when the temperature exceeds a certain value. The temperature is generally called a glass transition point Tg. Details about the glass transition point has been described in pages 119 and 120 of the “Garasu No Kagaku or Chemistry of Glass (1st edition published on 24 Apr., 1972).

In consequence, when the sealing temperature Tf is equal to or more than the glass transition point Tg unique to the dielectric material utilized for the dielectric layer, the difference in thermal expansion between the dielectric layer and MgO becomes larger and hence there appear cracks in proportion to the temperature difference.

In this situation, to achieve the first object above, there is provided in accordance with the present invention a gas-discharge display panel including a front substrate and a rear substrate which are sealed up by a sealing member. In the display panel, there exists a relation of Tg≧Tf between a glass transition point Tg of a dielectric substance formed on the front substrate and a temperature Tf at which the front substrate and the rear substrate are sealed up.

Additionally, there is provided a display including a gas-discharge display panel including a front substrate and a rear substrate and a driving circuit for supplying a driving waveform to the display panel in which a relationship of Tg≧Tf exists between a glass transition point Tg of a dielectric substance formed on the front substrate and a temperature Tf at which the front substrate and the rear substrate are sealed up.

Since the sealing is conducted at a temperature equal to or less than the glass transition point of the dielectric substance, the ratio of expansion of the dielectric layer becomes almost equal to that of the MgO film (i.e., does not abruptly increases), which can prevent the occurrence of cracks in the MgO film due to the expansion difference between the dielectric layer and the MgO film. Additionally, since the cracks occurring in the MgO film can be suppressed, the picture quality is retained.

In this connection, the protecting layer of the MgO film or the like is desirably produced through vacuum evaporation at a film forming temperature from about 250° C. to about 300° C. The MgO film grown under this condition is in a state in which a compressive stress appears in the cooling process thereof. It has been consequently known through experiments that in the MgO film grown at such a temperature, expansion of the dielectric layer can be suppressed in the sealing step thanks to the compressive stress existing therein. Results of experiments will be described later.

That is, in order to achieve the first object in accordance with the present invention, there is provided a gas-discharge display panel including a front substrate and a rear substrate which are sealed up by a sealing member, comprising a dielectric substance formed on the front substrate and a protective layer formed through a heating step on the dielectric substance. In the display panel, there exists a relationship of Tg≧(Tf−20° C.) between a glass transition point Tg of a dielectric substance formed on the front substrate and a temperature Tf at which the front substrate and the rear substrate are sealed up.

Alternatively, there is provided a display including a gas-discharge display panel including a front substrate and a rear substrate and a driving circuit for supplying a driving waveform to the display panel in which the front substrate includes a dielectric substance and a protective layer formed through a heating step on the dielectric substance and a relationship of Tg≧Tf−20° C.) exists between a glass transition point Tg of a dielectric substance formed on the front substrate and a temperature Tf at which the front substrate and the rear substrate are sealed up.

Incidentally, in either cases, the difference in expansion can be favorably removed in the sealing step by equalizing the thermal expansion coefficient of MgO to that of the dielectric material up to the glass transition point.

On the other hand, we have proved that a crystallizing material is required to be used as the sealing material to improve reliability of the sealing material in the high-temperature process.

Namely, in order to achieve the second object in accordance with the present invention, there is provided a gas-discharge display panel including a front substrate and a rear substrate which are sealed up by a sealing member, the sealing member including a crystallizing material.

Alternatively, there is provided a display including a gas-discharge display panel including a front substrate and a rear substrate and a driving circuit for supplying a driving waveform to the display panel, the sealing member including a crystallizing material.

In this case, it is favorable to utilize as the sealing member a material substantially crystallizing in the sealing step.

FIG. 6 shows a viscosity characteristic η for amorphous and crystallizing materials with respect to temperature.

As can be seen from the graph, even after the sealing step is completed, the amorphous material has a trend of softening with respect to the increase in temperature.

In contrast therewith, when the sealing step is carried out at a predetermined temperature, the crystallization continuously takes place in the crystallizing material until the crystallization is finally completed. Therefore, the characteristic of the crystallizing material up to the end of sealing step considerably differs from that after thereafter. It is consequently quite difficult to soften the crystallizing material, namely, the characteristic becomes almost fixed when compared with the crystallizing material before the end of sealing step.

Consequently, in a case in which the crystallizing material is used as the sealing material, when the sealing step is conducted at a temperature satisfying the first object, the crystallized sealing material is not easily softened even if an activation process is accomplished for the material at a temperature equal to or more than the sealing temperature. In consequence, it is possible to prevent the deterioration in strength of joint between the front substrate 100 and the rear substrate 200 and hence the leakage of the sealed discharge gas such as a rare gas is prevented. In other words, it is possible to improve the reliability in the high-temperature process when compared with the conventional technology.

As above, in accordance with the present invention, the decrease in the insulating voltage of the dielectric substance and the cracks in the MgO film are prevented and hence there can be provided a gas-discharge display panel and a display using the same capable of displaying a high-quality picture.

In addition, in accordance with the present invention, it is possible to improve reliability of the sealing material in the high-temperature process.

### BRIEF DESCRIPTION OF THE DRAWINGS

The objects and features of the present invention will become more apparent from the consideration of the following detailed description taken in conjunction with the accompanying drawings in which:

FIG. 1 is a cross-directional view showing an embodiment in accordance with the present invention;

FIG. 2 is a table showing results of experiments in accordance with the present invention;

FIG. 3 is a table showing results of experiments in accordance with the present invention;

FIG. 4 is a cross-directional view showing an example of the prior art;

FIG. 5 is a graph showing the principle of the present invention;

FIG. 6 is a graph showing the principle of the present invention;

FIG. 7 is a photo showing presence or absence of occurrence of cracks;

FIG. 8 is a photo showing presence or absence of occurrence of cracks;

FIG. 9 is a photo showing presence or absence of occurrence of cracks; and

FIG. 10 is a photo showing presence or absence of occurrence of cracks.

### DESCRIPTION OF THE PREFERRED EMBODIMENTS

Next, description will be given in detail of an embodiment in accordance with the present invention by referring to the accompanying drawings.

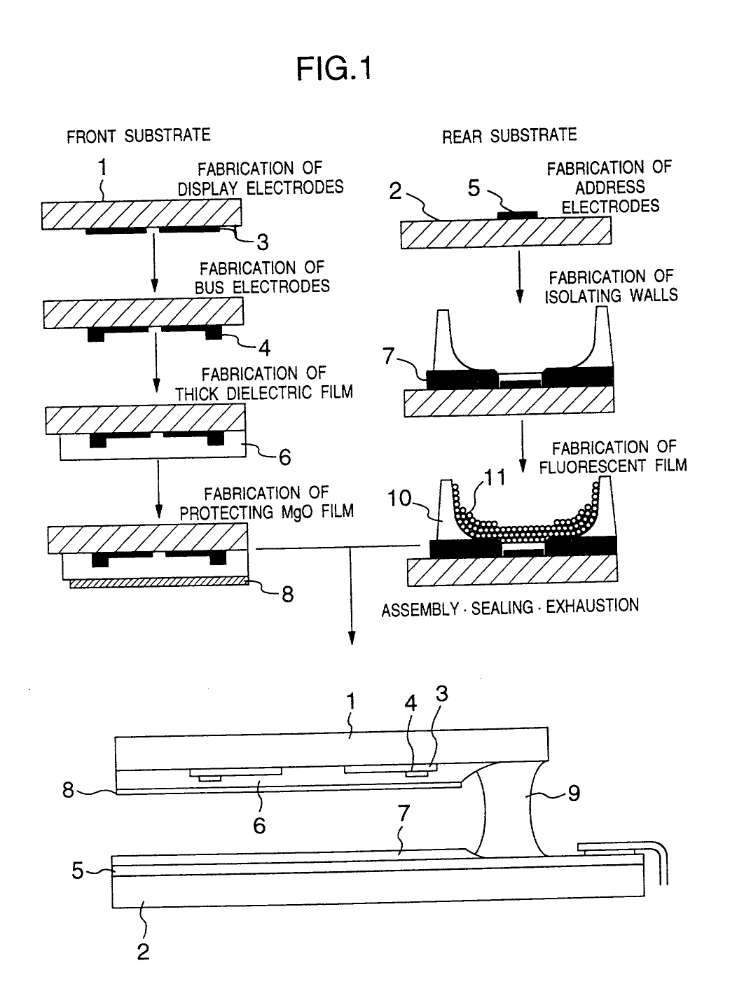

FIG. 1 shows constitution of a plasma display panel and an example of process of manufacturing the panel.

This diagram includes a front substrate 1, a rear substrate 2, transparent electrodes 3 formed on the substrate 1, metal electrodes 4 formed on the transparent electrodes 3, metal electrodes 5 formed on the rear substrate 2, thick dielectric layers 6 and 7 formed to respectively coat the transparent electrodes 3 and the metal electrodes 4 and 5, an MgO film 8, and a sealing member 9.

First, the transparent electrodes 3 and the metal electrodes 4 are manufactured on the front substrate 1 in photolithography and etching steps. Subsequently, the thick dielectric layer 6 is fabricated to almost entirely coat the transparent electrodes 3 and the metal electrodes 4. Thereafter, the MgO film 8 is formed in a vacuum on the fabricated dielectric layer 6. The MgO film 8 is fabricated entirely on the surface of the dielectric layer 6 with a small peripheral region left on the surface.

Similarly, the metal electrodes 5 and the thick dielectric layer 7 are fabricated on the rear substrate 2. Thereafter, isolating walls 10 are formed in the sand-blast process or the like and a fluorescent substance 11 is coated thereon.

The front substrate 1 and the rear substrate 2 manufactured as above are aligned to each other and the peripheral sections thereof are sealed up by the sealing member 9 as shown in the diagram. For example, an amorphous or crystallizing lead glass is generally adopted as the sealing material 9. Alternatively, there may also be used a vanadium glass depending on cases. Although not shown, after exhausting air of the internal space of the panel through a hole prepared in the rear substrate 2 to establish a vacuum state therein, the discharge gas such as a rare gas is introduced into the space to thereby produce the completed plasma display panel.

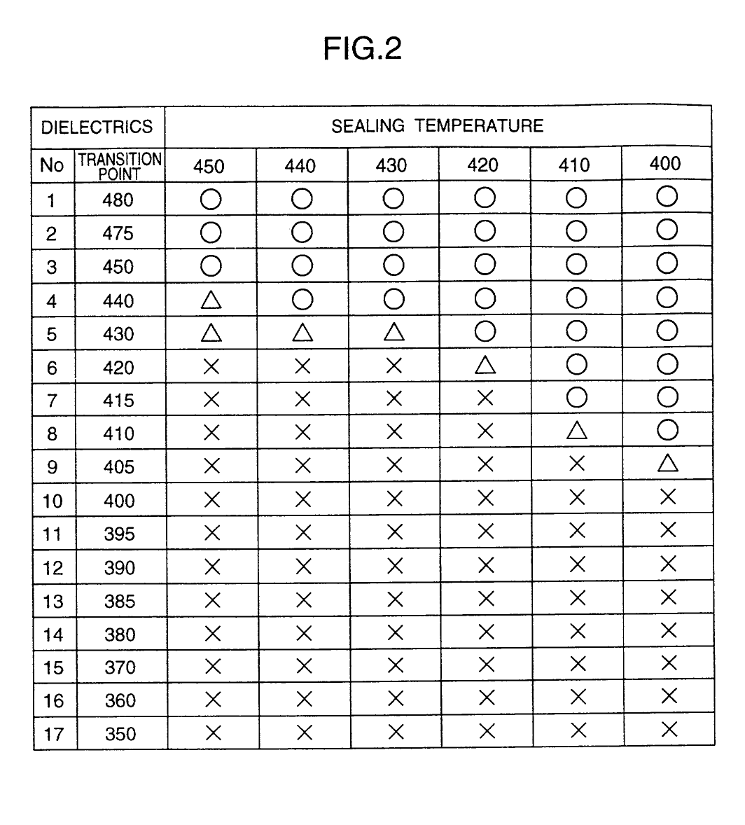

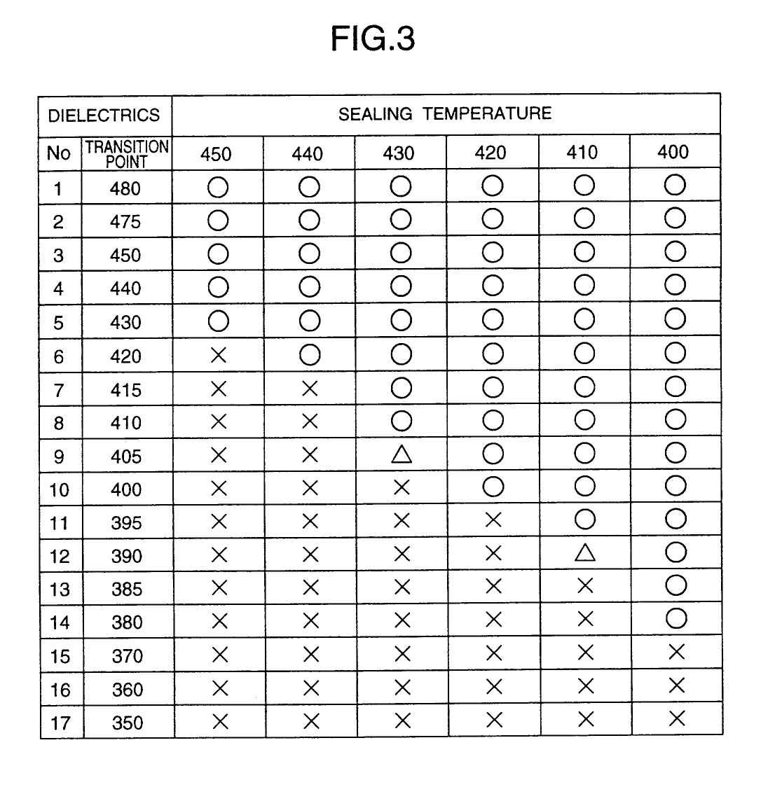

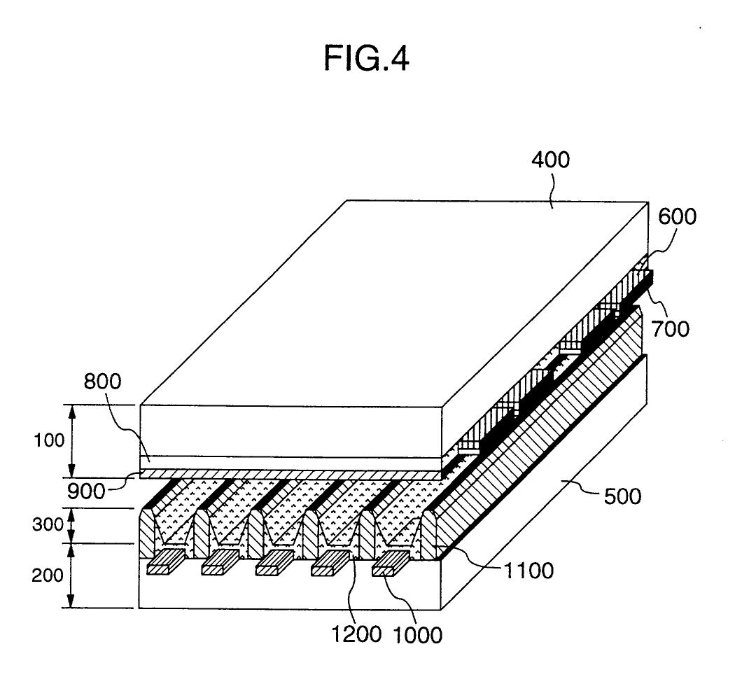

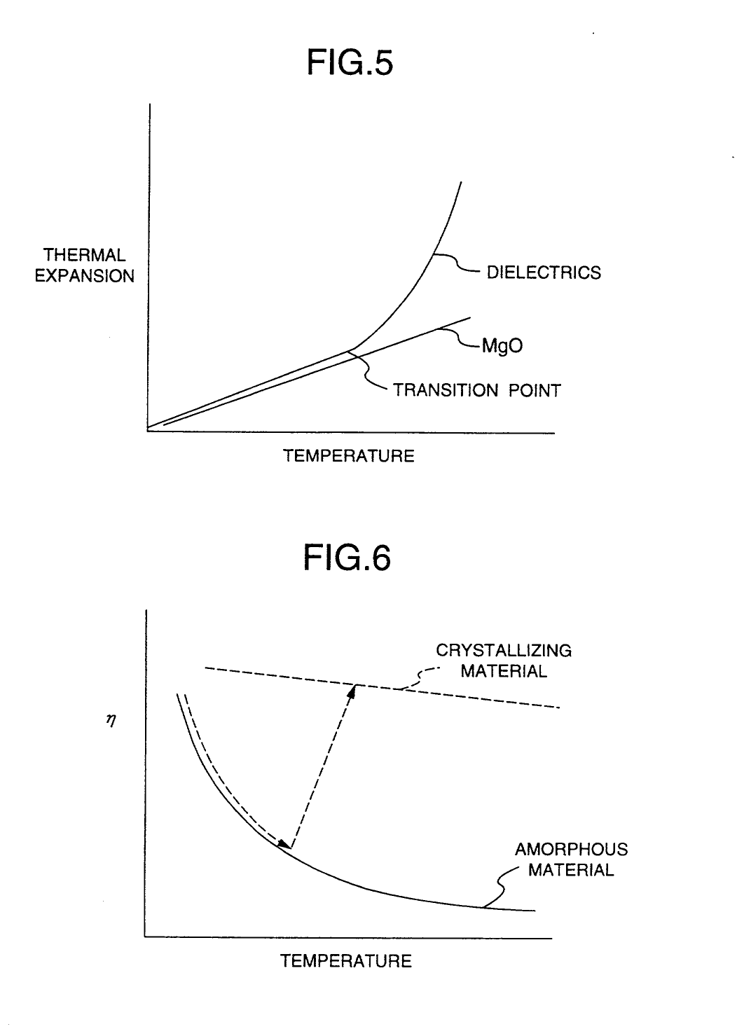

FIGS. 2 and 3 show relationships (results of experiments) between the glass transition point Tg (350° C.≦Tg≦480° C.) of the dielectric material as the thick dielectric layer 6 and the sealing temperature (400° C.≦Tf≦450° C.) in the plasma display panel constructed as above. A lead borosilicate dielectric substance is employed as the thick dielectric layer 6. In this connection, FIGS. 2 and 3 are experimental results respectively obtained when the MgO is fabricated at a room temperature and at a temperature of about 250° C., respectively. It is also possible to use a vanadium glass as the dielectric material of the dielectric layer 6.

As can be seen from FIGS. 2 and 3, there appears no crack when Tg≧Tf is satisfied for the MgO film grown at a room temperature and Tg≧(Tf−20° C.) is satisfied for the MgO film grown at 250° C.

That is, it is to be appreciated that the thermal expansion of the thick dielectric layer becomes approximately equal to that of the MgO film when the conditions above are satisfied (i.e., the thick dielectric layer is within the glass transition point and hence the abrupt thermal expansion thereof is suppressed) and consequently no crack appears in the MgO film. Additionally, it can also be confirmed that when the MgO film is grown at about 250° C., the compressive stress resultantly occurring therein develops an effect to suppress cracks.

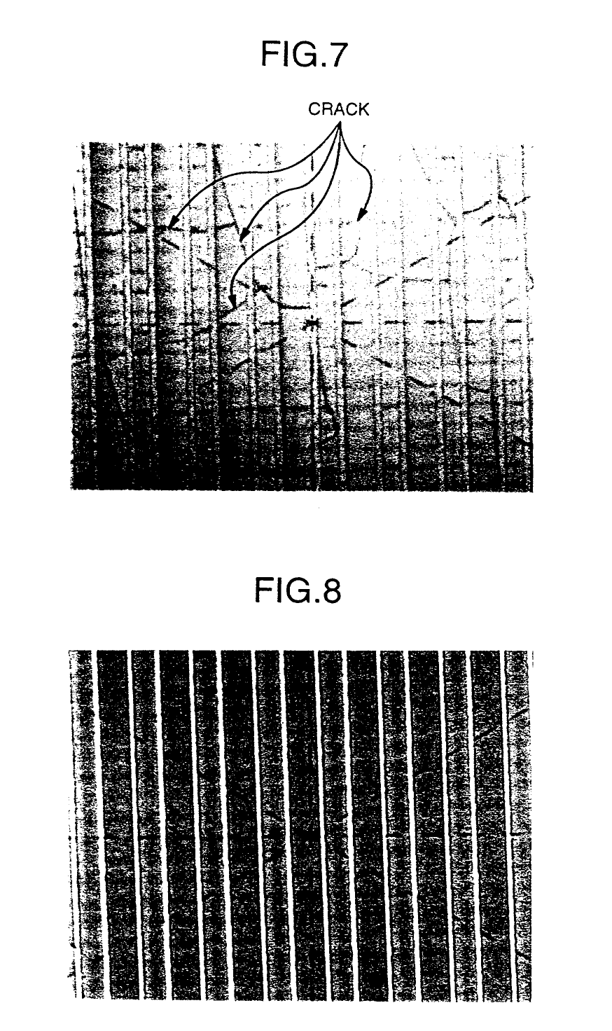

FIGS. 7 to 10 are photos showing presence or absence of occurrence of cracks in samples shown in FIG. 3.

FIG. 7 related to a case in which sample 10 (softening point 400° C.) is sealed at about 430° C. shows occurrence of cracks.

FIG. 8 associated with a case in which sample 10 (softening point 400° C.) is sealed at about 410° C. shows no crack.

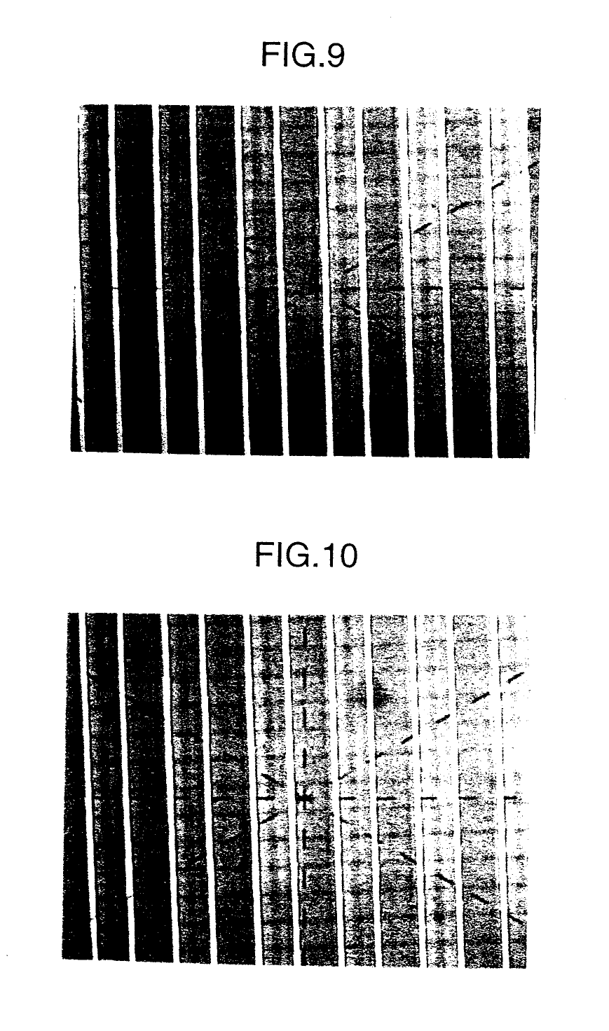

FIG. 9 associated with a case in which sample 7 (softening point 415° C.) is sealed at about 430° C. shows no crack.

FIG. 10 associated with a case in which sample 7 (softening point 415° C.) is sealed at about 410° C. shows no crack.

In accordance with the results of experiments, it is known that no crack takes place when Tg≧(Tf−20° C.) is satisfied.

In the embodiment, description has been given of results of experiments in which the MgO film is grown at about 250° C. This is substantially an upper-limit film growing condition derived from a relationship between the volume of gas generated in the high-temperature process and influence thereof onto the vacuum. However, the present invention is not to be restricted by this example.

Moreover, it is to be appreciated that even if the protective layer is fabricated with a material other than MgO, almost the same effect can be obtained when there is employed a material which has a high secondary-electron emission characteristic and which is quite resistive against sputtering in accordance with the principle of the present invention.

Additionally, even when a thin insulating inorganic film is formed between the thick dielectric layer and the MgO film, it is possible to prevent cracks which may be caused by the difference in thermal expansion between the thick dielectric layer and the thin insulating inorganic film as well as between the thick dielectric layer and the MgO film.

Furthermore, the structure of the front substrate and the rear substrate and the contour of the isolating wall are not restricted by the example above. For example, even when the isolating wall has a contour of a box or the isolating wall is formed on the front substrate, the similar effect is obtainable. Namely, the advantageous effect of the present invention is obtainable by utilizing materials satisfying the relationship between Tg and Tf in accordance with the present invention.

While the present invention has been described with reference to the particular illustrative embodiments, it is not to be restricted by those embodiments but only by the appended claims. it is to be appreciated that those skilled in the art can change or modify the embodiments without departing from the scope and spirit of the present invention.

1. A gas-discharge display panel, comprising:
a front substrate; and
a rear substrate to be sealed up with the front substrate by a sealing member, wherein
a relationship of Tg≧Tf exists between a glass transition point Tg of a dielectric substance formed on the front substrate and a temperature Tf at which the front substrate and the rear substrate are sealed up.

2. A display, comprising:
a gas-discharge display panel including a front substrate and a rear substrate; and
a driving circuit for supplying a driving waveform to the display panel, wherein
a relationship of Tg≧Tf exists between a glass transition point Tg of a dielectric substance formed on the front substrate and a temperature Tf at which the front substrate and the rear substrate are sealed up.

3. A gas-discharge display panel, comprising:
a front substrate;
a rear substrate to be sealed up with the front substrate by a sealing member;
a dielectric substance formed on the front substrate; and
a protective layer formed on the dielectric substance through a heating process, wherein
a relationship of Tg≧(Tf−20° C.) exists between a glass transition point Tg of the dielectric substance formed on the front substrate and a temperature Tf at which the front substrate and the rear substrate are sealed up.

4. A display, comprising:
a gas-discharge display panel including a front substrate and a rear substrate;
a driving circuit for supplying a driving waveform to the display panel;
a dielectric substance formed on the front substrate; and
a protective layer formed through a heating step on the dielectric substance, wherein
a relationship of Tg≧(Tf−20° C.) exists between a glass transition point Tg of the dielectric substance formed on the front substrate and a temperature Tf at which the front substrate and the rear substrate are sealed up.

5. A gas-discharge display panel, comprising:
a front substrate; and
a rear substrate to be sealed up with the front substrate by a sealing member, wherein
the sealing member includes a crystallizing material.

6. A gas-discharge display panel in accordance with claim 5, wherein the sealing member includes a material substantially crystallizing in the sealing step.

7. A display, comprising:
a gas-discharge display panel including a front substrate and a rear substrate; and
a driving circuit for supplying a driving waveform to the display panel, wherein
the sealing member includes a crystallizing material.

8. A display in accordance with claim 7, wherein the sealing member includes a material substantially crystallizing in the sealing step.

9. A method of manufacturing a gas-discharge display panel, comprising the steps of:
forming transparent electrodes and first electrodes on a front substrate;
forming a thick dielectric layer with a dielectric substance having a glass transition point of Tg on the front substrate, the layer covering substantially the overall surface of the transparent and first electrodes;
forming a protective layer on the thick dielectric layer, the layer emitting secondary electrons;
forming second electrodes on a rear substrate;
forming a thick dielectric layer with a dielectric substance having a glass transition point of Tg on the rear substrate and the second electrodes;
aligning the front substrate onto the rear substrate and sealing up the front and rear substrates by a sealing agent at a sealing temperature of Tf (Tf≦Tg); and
exhausting air from a space formed by sealing up the front substrate and the rear substrate to a vacuum and introducing a discharge gas into the space.

10. A method of manufacturing a gas-discharge display panel, comprising the steps of:
forming transparent electrodes and first electrodes on a front substrate;
forming a thick dielectric layer with a dielectric substance having a glass transition point of Tg on the front substrate, the layer covering substantially the overall surface of the transparent and first electrodes;
forming a protective layer on the thick dielectric layer, the layer emitting secondary electrons;
forming second electrodes on a rear substrate;
forming a thick dielectric layer with a dielectric substance having a glass transition point of Tg on the rear substrate and the second electrodes;
aligning the front substrate onto the rear substrate and sealing up the front and rear substrates by a sealing agent at a sealing temperature of Tf (Tf≦Tg+20° C.); and
exhausting air from a space formed by sealing up the front substrate and the rear substrate to a vacuum and introducing a discharge gas into the space.
